(19) United States
(12) Patent Application Publication
(10) Pub. No.: US 2008/0229527 A1
(43) Pub. Date: Sep. 25, 2008

(54) Rotary chimney brush apparatus

(76) Inventor: Robert B. Berry, Spring Hill, KS (US)

Correspondence Address: SHUGHART THOMSON & KILROY, PC, 120 WEST 12TH STREET, KANSAS CITY, MO, 64105, US

(21) Appl. No.: 11/725,868

(22) Filed: Mar. 20, 2007

(51) Int. Cl. B08B 9/00

(52) U.S. Cl. 15/3

(57) ABSTRACT

A rotary chimney brush apparatus includes an elongated push rod which has a selected degree of flexibility, a motor mounted on an outer end of the push rod, and a brush member mounted on a shaft of the motor. The push rod is coiled up into a spool structure which is rotatably mounted on a base frame. Electrical conductors extend along the push rod from a set of batteries and a switch unit to the motor to supply electrical power to the motor to rotate the brush. The push rod and conductors are enclosed in an outer sheath The push rod is extended from the spool to move the rotating brush up through a chimney to clean it. As the brush is lowered through the chimney, the push rod is retracted back into the spool for carrying and storage.

### BACKGROUND OF THE INVENTION

The present invention is related to equipment for cleaning vertical and horizontal passageways of air handlers, ducts, and fireplace chimneys and, more particularly, to a rotary chimney brush apparatus which is fed up a chimney from a fireplace.

Duct works build up debris due to materials entrained in air flowing though them. Chimneys build up soot and creosote and other products of combustion which, ideally, are drawn upwardly by convection through an associated chimney and released to the atmosphere. In practice, however, some combustion products condense and otherwise adhere to inner surfaces of the chimney or, more properly, the chimney flue. The buildup of such deposits reduces the cross sectional area of the chimney over periods of time and, thus, reduces the flow efficiency of the chimney. Additionally, the deposits can include combustible substances which burn at high temperatures if ignited. Such chimney fires can be damaging to the chimney and can also ignite surrounding structures. Therefore, for reasons of safety and efficiency, chimneys should be inspected regularly and cleaned when necessary.

Various types of brushes are used for mechanical abrasion of chimney deposits, including those with polymer bristles, metal bristles, and the like. Deposits can be removed to some extent by moving a brush up and down within the chimney; however, in order to more effectively remove the deposits, the brushes are sometimes motorized to spin. At least one known system uses a chain to lower a motorized brush into a chimney. Another uses a fixed position motor engaged with a helically grooved shaft which lowers a brush into the chimney by rotating in one direction and lifts it out by reversing the motor. Another chimney cleaning system makes use of a flexible shaft to which is connected a small motor, such as a hand drill, to rotate the shaft with a brush attached on the end. In addition to brushes, other cleaning implements may be employed, such as looped cables, chains, steel balls, and the like to dislodge particularly hardened deposits within chimneys. A common method of extending a brush through a chimney is to connect several sections of rods in end-to-end fashion by threaded sockets, as the brush is pushed through the chimney flue. The need to assemble the composite or metal rod to extend the brush into the chimney and to disassemble the rod as the brush is removed from the chimney is laborious.

A particular hazard for chimney sweeps or chimney cleaning personnel is the need to climb up onto roofs to lower cleaning equipment down through the chimney outlet. The hazards of falls and falling equipment are increased in northern areas which have steeper roofs to shed snow and in relation to multi-story buildings. What is needed is equipment for effectively and efficiently cleaning chimneys which is convenient, compact, and safe to use.

### SUMMARY OF THE INVENTION

The present invention provides a rotary cleaning brush apparatus powered by a remote motor which is fed up a chimney from the fireplace by means of a flexible, non-rotary feed shaft or push rod. An electric motor is mounted at an outer end of the shaft and has any one of a variety of chimney cleaning tools mounted on its motor shaft, such as a brush with polymer or metal bristles, a looped cable, or other conventional chimney cleaning tool. A power cable for the motor passes either along or through the push rod and is connected to a power source at an opposite end of the feed shaft. In one embodiment of the invention, the power source includes one or more batteries, such as gelled lead-acid batteries, to power a reversible DC (direct current) motor. The power source preferably includes control switches or a control switch unit for causing rotation the motor shaft in one direction, in an opposite direction, and deactivation of the motor. Alternatively, the power source may be an AC (alternating current) source, such as a conventional AC outlet, an inverter to power an AC motor from a battery, or the like.

The apparatus includes a reel or spool to store the push rod in a rolled up configuration and rotates to pay out the push rod to extend up into the chimney and to retract the push rod from the chimney. The push rod is flexible enough to allow compact storage and carriage, but stiff enough to allow a brush to be extended into a chimney without being twisted excessively by reaction to the torque generated by frictional resistance to the rotating brush engaging surfaces of the chimney flue. Thus, the push rod tends to straighten out when not constrained by the spool. The spool includes a base frame on which the spool itself is rotatably mounted. The spool includes a spool frame extending from the hub and terminating in a circumferential barrier which is engaged radially outwardly by the push rod when stored in the spool.

In one embodiment of the apparatus, the spool includes a plurality of J-shaped hook or spoke members having long sides thereof joined to the hub and radiating therefrom. Short sides of the spokes are joined with a ring which forms an opens side of the spool. Bight sections of the spoke members form a circumferential barrier of the spool which is engaged radially outwardly by the push rod when rolled up within the spool. The push rod with the rotary brush on the outer end is fed out from the spool through the ring and retracted back into the spool through the ring.

The base frame may take any suitable form of framework which can rotatably support the spool. In one embodiment, the base frame includes a pair of spaced apart, parallel ground or floor engaging runners connected by cross members. Each runner has a roughly semi-circular arched rail extending upwardly therefrom with bearings at the apex in which a hub of the spool is mounted. The runners, rails, and cross members may be formed of tubular members formed of aluminum, steel, various sturdy plastics, or the like. The spool and base frame enable the apparatus to be carried compactly and conveniently and allow the apparatus to be set up at a customer's fireplace and packed up quickly when the cleaning job has been completed.

The battery or batteries for powering the brush motor are preferably mounted on or within the spool, such as on a spoke or spokes. The control switch unit is also mounted on one of the spokes. Conductors extending from the switch unit to the motor are routed along the push rod. The push rod and conductors may be enclosed in a tubular sheath to form a composite push rod or push rod assembly. Alternatively, the conductors can extend along the push rod with ties of some sort spaced along the assembly to gather the push rod and conductors at suitable intervals along the push rod assembly. The push rod could also be manufactured as a composite with the conductors embedded in and extending along the push rod, thereby avoiding a need for a sheath, ties or the like.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a rotary chimney brush apparatus which embodies the present invention.

FIG. 2 is an enlarged fragmentary perspective view illustrating a brush motor and brush on an end of a push rod of the apparatus.

FIG. 3 is a fragmentary perspective view at a reduced scale and illustrates the apparatus with a brush on the end of the push rod extending from the storage spool and into a chimney.

FIG. 4 is a greatly enlarged cross sectional view taken on line 4-4 of FIG. 2 and illustrates internal details of an exemplary embodiment the push rod.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

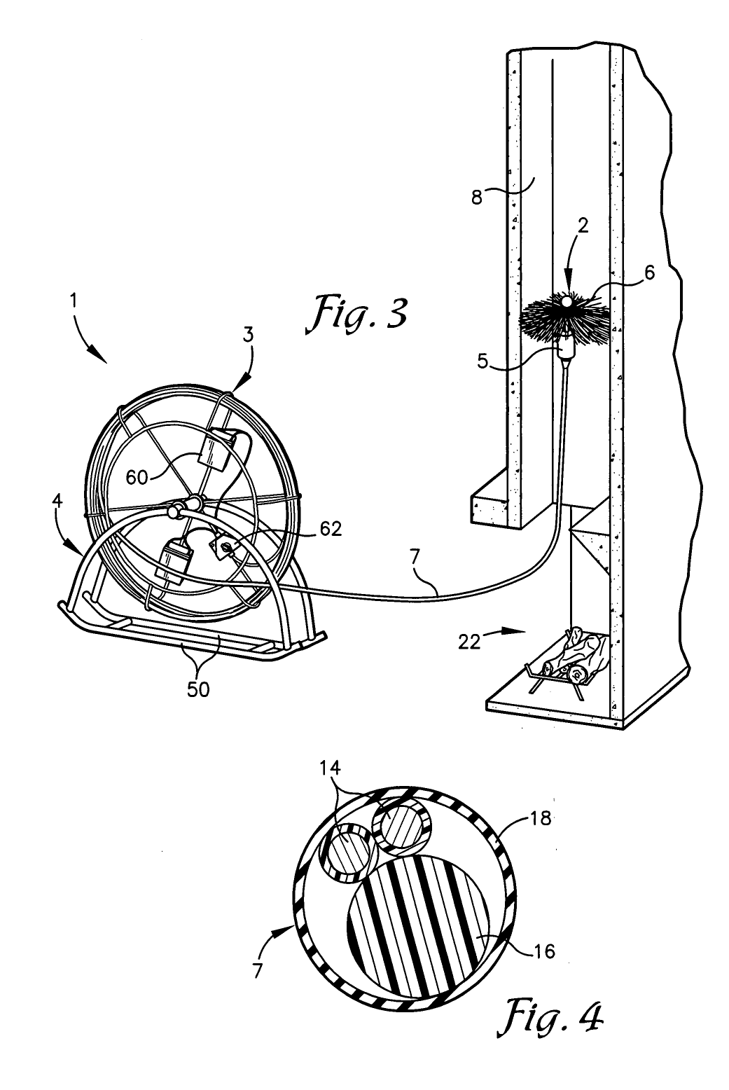

Referring to the drawings in more detail, the reference numeral 1 generally designates a rotary chimney brush apparatus which embodies the present invention. The apparatus generally 1 includes a brush assembly 2 stored within a spool 3 which is rotatably supported on a base frame 4. The brush assembly 2 includes a rotary motor 5 having a chimney cleaning tool 6, such as a brush, mounted thereon, both positioned at an outer end of a push rod 7. The brush assembly 2 is payed out from the spool 3 to extend the brush 6 into a passage such as a chimney 8 (FIG. 3) for cleaning it and retracted back into the spool 3 to store the brush assembly 2 therein.

The push rod 7 includes a pair of electrical conductors 14 (FIG. 4) which extend therealong to the motor 5 and provide operating power thereto. In the embodiment illustrated in FIG. 4, the push rod 7 is a composite push rod or push rod assembly, including a push rod member 16, the insulated power conductors 14, and an outer sheath 18. It is foreseen that the push rod 7 could be embodied in an alternative manner. For example, the conductors 14 could extend along the push rod member 16 with bands or ties (not shown) to gather the conductors and push rod member at intervals spaced therealong. Alternatively, the push rod member 16 could be tubular (not shown) with the conductors 14 extending through such a tubular push rod member. Or the push rod 7 could be manufactured as a composite, such as fiber glass, with the conductors 14 embedded within the push rod 7.

In the illustrated embodiment, the push rod member 16 is a continuous rod of a material such as fiber glass. Alternatively, other materials could be employed, such as certain kinds of plastics, metals, or other types of composites. The push rod assembly 7 has a degree of flexibility to enable it to be rolled up into the spool 3. It also has a degree of stiffness such that it tends to straighten out when unconstrained to thereby enable the brush assembly 2 to be pushed up into a chimney 8 against frictional resistance of the brush 6 engaging the inner surfaces of the chimney 8. The push rod must also be torsionally stiff enough to resist excessive twisting in reaction to rotation of the brush 6 by the motor 5 and frictional resistance to rotation of the brush 6 within the chimney 8. For practical purposes, the push rod 7 should have a length of at least several stories to reach from in front of a fireplace 22 to beyond a chimney cap (not shown) of the chimney 8.

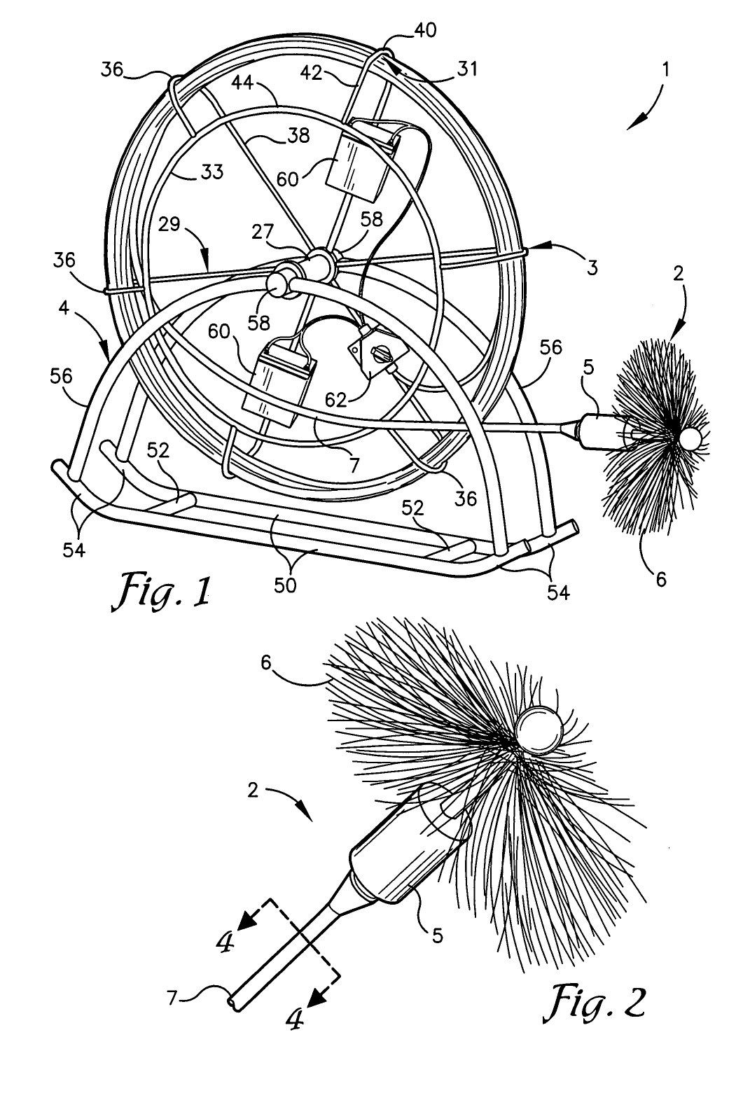

The spool 3 includes a mounting hub 27 (FIG. 1) defining a spool axis, a spool frame 29 extending radially from the hub 27, and a circumferential barrier 31 extending from the spool frame 29 in axial relation to the hub 27. The spool 3 preferably includes a spool opening 33, which is not obstructed or interfered with by the spool frame 29, on at least one side to facilitate extending the brush assembly 2 out of the spool 3 and retracting it back into the spool. The push rod 7 engages the barrier 31 in a radially outward direction when stored within the spool 3 because of its tendency to unwind, due to its stiffness.

In the illustrated spool 3, the spool frame 29 and barrier 31 are formed by J-shaped spoke members or spokes 36 extending radially from the hub 27 in angularly spaced relation. Longer legs 38 of the spokes 36 form the spool frame 29, while curved connection portions or bight sections 40 form the circumferential barrier 31. Shorter legs 42 of the spokes 36 extend radially inwardly and connect to a spool ring 44 which defines the opening 33 of the spool 3. The spokes 36 and ring 44 can be formed of heavy wire stock which has a resilient quality to retain their shapes or from other materials such as plastics.

The spool 3 can be used as is to store and carry the brush assembly 2. However, the apparatus 1 may also include the ground engaging base frame or assembly 4, on which the spool 3 is rotatably mounted. The base 4 may take any suitable form. The illustrated base 4 includes a pair of lower members or runners 50 connected in parallel, spaced relation by two or more cross members 52. Opposite ends 54 of the runners 50 may be curved upwardly somewhat to facilitate manipulating the apparatus 1 in the field, without snagging carpeting or marring of wooden floors. Each of the runners 50 includes an upwardly curving, roughly semi-circular arch members 56, with a bearing 58 at its apex. The bearings 58 have the spool hub 27 rotatably mounted therein. Rotation of the spool 3 about the hub 27 allows convenient extension of the brush assembly 2 out of the spool 3 and retraction of it back into the spool.

The brush motor 5 is preferably a reversible direct current motor having a horsepower rating and rotational speed comparable to a hand drill. The power for the motor 5 may be supplied by one or more batteries 60 through a control unit 62. The illustrated apparatus 1 has a pair of batteries 60 mounted on opposed spokes 36. The batteries 60 may be gelled lead acid batteries having an ampere-hour rating which is a compromise between extended use in the field without recharging and convenient portability of the apparatus 1. The control unit 62 may be a switch unit with switch settings to control a relative forward rotational direction of the motor, a reverse direction, and an off setting. It is foreseen that the control unit 62 may incorporate a motor speed control, such as a variable resistor (not shown). It is also foreseen that the motor 5 could be an alternating current motor or that direct current power for a DC motor 5 could be derived from alternating current by a power supply circuit (not shown).

FIG. 2 illustrates an exemplary chimney cleaning tool 6 in the form of a brush. The brush 6 may employ bristles formed of natural materials, synthetic materials, such as plastics, or metals. The brush 6 may attach to the shaft of the motor 5, as by the use of a threaded socket, a non-round socket with a set screw, a clamp, or the like. Rotation of the brush 6 by the motor 5 and up and down reciprocating motion of the rotating brush 6 causes ends of the bristles to frictionally engage deposits within the chimney 8. Such action is capable of dislodging most deposits within the chimney. However, some deposits become hardened on the surfaces of the chimney, such that they are not easily dislodged by action of the rotating brush 6. Other types of chimney cleaning tools are known within the industry, such as tools incorporating looped sections of metal cable, sections of chains, metal balls on chains, and the like. Such alternative types of tools 6 are also suitable for use with the apparatus 1.

In typical use, the brush assembly 2 is coiled into the spool 3 and brought to the home site. Collection tarpaulins or bags may be positioned at the fireplace 22 to collect ashes and other deposits which are removed from surfaces of the chimney 8. The apparatus 1 is positioned in front of the fireplace 22, and the brush assembly 2 is extended out of the spool through the spool opening 33. If a damper (not shown) is present in the chimney 8, it is opened fully, and the brush 6 is extended into the opening chimney 8. The motor 5 is activated by operation of the control unit 62, thereby causing the brush 6 to rotate. The brush assembly 2 is extended upwardly through the chimney 8 to dislodge deposits from the chimney 8. As the brush assembly 2 is lowered, the push rod 7 is coiled back into the spool 3. The process can be repeated if necessary until the chimney 8 is sufficiently cleaned. If alternate tools cleaning 6 are required, they may be substituted for the brush. The apparatus 1 is self-contained and can be quickly packed up when the cleaning job is done. Although the apparatus 1 is particularly well adapted for cleaning the chimney 8 by extending the brush assembly 2 upwardly from a position in front of a fireplace 22, it is also possible to use the apparatus 1 by lowering the brush assembly 2 through the chimney 8 from a position on the roof of a building.

While the apparatus 1 has been described principally in terms of cleaning chimneys, it is foreseen that the apparatus 1 could also be adapted for cleaning or removing deposits from other types of passages, such as air ducts, sewer lines, well casings, and the like. Such adaptations and alternative uses of the apparatus 1 are intended to be encompassed by the present invention.

It is to be understood that while certain forms of the present invention have been illustrated and described herein, it is not to be limited to the specific forms or arrangement of parts described and shown.

What is claimed and desired to be secured by Letters Patent is:

1. A passage cleaning apparatus for use in removing deposits from inner surfaces of a passage and comprising:
(a) an elongated push rod having an outer end and an inner end, said push rod having a selected degree of resilient flexibility;
(b) an electric motor positioned at said outer end of said push rod, said motor including a rotary motor shaft;
(c) a rotary chimney cleaning tool connected to said motor shaft to rotate therewith;
(d) elongated electrical conductors connected to said motor and extending along said push rod toward said inner end to enable connection of said motor to a source of electrical power to thereby cause said motor to rotate said tool; and
(e) said push rod cooperating with said motor and said tool to enable extension of said tool through said chimney flue to remove deposits therefrom and withdrawal of said tool therefrom.

2. An apparatus as set forth in claim 1 and including:
(a) a rotary storage spool adapted to store said push rod in a rolled up condition.

3. An apparatus as set forth in claim 2 and including:
(a) a ground engaging base; and
(b) said spool being rotatably supported on said base.

4. An apparatus as set forth in claim 2 wherein said pushrod has a degree of stiffness which causes it to tend to straighten out when unconstrained, and wherein said spool includes:
(a) a hub defining a spool axis;
(b) a spool frame extending radially from said hub; and
(c) a circumferential barrier extending axially from said spool frame and radially outwardly engaged by said push rod when supported in a rolled up condition within said spool.

5. An apparatus as set forth in claim 1 and including a rotary storage spool to store said push rod in a rolled up condition, said spool including:
(a) a hub member;
(b) a plurality of J-shaped hook members, each hook member having a long side and a short side connected by a curved section, said hook members being connected by said long sides to said hub in radiating relation;
(c) a circular ring joined to said short sides of said hook members;
(d) said push rod being stored within said spool in said rolled up condition by engaging said curved sections of said hook members; and
(e) said push rod being extended from and retracted into said spool through said ring.

6. An apparatus as set forth in claim 5 and including:
(a) a ground engaging base having said spool rotatably connected thereto at said hub, said base orienting said spool to rotate about a horizontal axis.

7. An apparatus as set forth in claim 1 wherein:
(a) said source of electrical power is a battery.

8. An apparatus as set forth in claim 1 wherein:
(a) said electric motor is a reversible direct current motor;
(b) said source of electrical power is a battery; and
(c) a polarity switch unit connects said battery to said conductors to enable operation of said motor with said shaft rotating in a first direction or an opposite second direction or deactivation of said motor.

9. An apparatus as set forth in claim 1 wherein:
(a) said electric motor is an alternating current motor; and
(b) said source of electrical power is an alternating current outlet.

10. A chimney cleaning apparatus for use in removing deposits from inner surfaces of a chimney flue and comprising:
(a) an elongated push rod having an outer end and an inner end, said push rod having a selected degree of resilient flexibility;
(b) an electric motor positioned at said outer end of said push rod, said motor including a rotary motor shaft;
(c) a rotary chimney cleaning tool connected to said motor shaft to rotate therewith;
(d) elongated electrical conductors connected to said motor and extending along said push rod toward said inner end to enable connection of said motor to a source of electrical power to thereby cause said motor to rotate said tool;
(e) said push rod cooperating with said motor and said tool to enable extension of said tool through said chimney flue to remove deposits therefrom and withdrawal of said tool therefrom;
(f) a ground engaging base; and
(g) a spool rotatably supported on said base to store said push rod in a rolled up condition, said spool rotating in a first spool direction to feed said push rod out of said spool and rotating in an opposite spool direction to retract said push rod back into said spool.

11. An apparatus as set forth in claim 10 wherein:
(a) said electric motor is a reversible direct current motor;
(b) said source of electrical power is a battery mounted on said spool; and
(c) a polarity switch unit is mounted on said spool and connects said battery to said conductors to enable operation of said motor with said shaft rotating in a first direction or an opposite second direction or deactivation of said motor.

12. An apparatus as set forth in claim 10 wherein said pushrod has a degree of stiffness which causes it to tend to straighten out when unconstrained, and wherein said spool includes:
(a) a hub defining a spool axis;
(b) a spool frame extending radially from said hub; and
(c) a circumferential barrier extending axially from said spool frame and radially outwardly engaged by said push rod when supported in a rolled up condition within said spool.

13. An apparatus as set forth in claim 12 wherein:
(a) said spool has an opening on one side to enable said push rod to be fed out through said opening and fed back into said spool therethrough.

14. An apparatus as set forth in claim 10 wherein:
(a) said electric motor is an alternating current motor; and
(b) said source of electrical power is an alternating current outlet.

15. An apparatus as set forth in claim 10 wherein said spool includes:
(a) a hub member;
(b) a plurality of J-shaped hook members, each hook member having a long side and a short side connected by a curved section, said hook members being connected by said long sides to said hub in radiating relation;
(c) a circular ring joined to said short sides of said hook members;
(d) said push rod being stored within said spool in said rolled up condition by engaging said curved sections of said hook members; and
(e) said push rod being extended from and retracted into said spool through said ring.

16. A chimney cleaning apparatus for use in removing deposits from inner surfaces of a chimney flue and comprising:
(a) an elongated push rod having an outer end and an inner end, said push rod having a selected degree of resilient flexibility, said pushrod having a degree of stiffness which causes it to tend to straighten out when unconstrained;
(b) an electric motor positioned at said outer end of said push rod, said motor including a rotary motor shaft;
(c) a rotary chimney cleaning tool connected to said motor shaft to rotate therewith;
(d) elongated electrical conductors connected to said motor and extending along said push rod toward said inner end to enable connection of said motor to a source of electrical power to thereby cause said motor to rotate said tool;
(e) said push rod cooperating with said motor and said tool to enable extension of said tool through said chimney flue to remove deposits therefrom and withdrawal of said tool therefrom;
(f) a ground engaging base;
(g) a spool rotatably supported on said base to store said push rod in a rolled up condition, said spool rotating in a first spool direction to feed said push rod out of said spool and rotating in an opposite spool direction to retract said push rod back into said spool, said spool including:
(1) a hub defining a spool axis;
(2) a spool frame extending radially from said hub; and
(3) a circumferential barrier extending axially from said spool frame and radially outwardly engaged by said push rod when supported in a rolled up condition within said spool; and
(g) said spool having an opening on one side to enable said push rod to be fed out through said opening and fed back into said spool therethrough.

17. An apparatus as set forth in claim 16 wherein:
(a) said electric motor is a reversible direct current motor;
(b) said source of electrical power is a battery mounted on said spool; and
(c) a polarity switch unit is mounted on said spool and connects said battery to said conductors to enable operation of said motor with said shaft rotating in a first direction or an opposite second direction or deactivation of said motor.

18. An apparatus as set forth in claim 16 wherein said spool includes:
(a) a hub member;
(b) a plurality of J-shaped hook members, each hook member having a long side and a short side connected by a curved section, said hook members being connected by said long sides to said hub in radiating relation;
(c) a circular ring joined to said short sides of said hook members;
(d) said push rod being stored within said spool in said rolled up condition by engaging said curved sections of said hook members; and
(e) said push rod being extended from and retracted into said spool through said ring.

19. An apparatus as set forth in claim 16 wherein:
(a) said electric motor is an alternating current motor; and
(b) said source of electrical power is an alternating current outlet.
